(19) United States
(12) Patent Application Publication
(10) Pub. No.: US 2005/0195261 A1
(43) Pub. Date: Sep. 8, 2005

(54) Fuser for ink jet images and ink formulations

(75) Inventors: Eric C. Stelter, Pittsford, NY (US); John C. Wilson, Rochester, NY (US); David D. Putnam, Fairport, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/072,781

(22) Filed: Mar. 4, 2005

Related U.S. Application Data
(60) Provisional application No. 60/550,596, filed on Mar. 5, 2004.

(51) Int. Cl. B41J 2/01

(52) U.S. Cl. 347/102

(57) ABSTRACT

Fixing agents that preferably contain a mordant, and printing methods using the fixing agents to fix an ink image to a receiver are described. Also described are printing systems that include an ink image forming device such as ink jet printer print head for producing an ink image on a receiver; a supply of a fixing agent for applying to the receiver; and a fuser for fixing the ink image to the receiver.

### CROSS-REFERENCE TO RELATED APPLICATION

Reference is made to the co-pending, commonly assigned, U.S. Provisional Patent Application Ser. No. 60/550,596 filed on Mar. 5, 2004, entitled: FUSER FOR INK JET IMAGES AND INK FORMULATIONS, the disclosure of which is incorporated herein by reference.

### BACKGROUND OF THE INVENTION

The present invention relates to printing systems and methods, and printed images produced from the same. More particularly, the present invention relates to a fixing agent useful in fixing an ink image to a receiver, and ink compositions that enable fixing.

Water-based ink jet printed images are subject to degradation from several causes. For example, ink jet images are susceptible to image deterioration caused by image spreading due to wicking in a receiver, smearing, distortion, and the like due, for example, to mechanical abrasion. Mechanical abrasion or “image rub-off” can be caused, for instance, by feeding of the image receiver through friction fed finishing equipment.

Accordingly, a need exists to improve ink jet image resolution and durability by improving the drying or fixing rate of ink images, and consequently reducing image spread.

### SUMMARY OF THE PRESENT INVENTION

It is therefore a feature of the present invention to provide fixing agents and processes using the fixing agents for fixing an ink jet image to a receiver.

Another feature of the present invention is to provide a process for fixing an ink jet image to a receiver that involves using a fuser member in conjunction with a fixing agent that contains a mordant.

An additional feature is to provide an ink composition containing pigments or dyes combined with fusible material.

A further feature of the present invention is to provide a receiver bearing an ink jet image having superior image permanence.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention in part relates to a printing method that includes transferring an ink image to a receiver; applying at least one fixing agent, e.g., mordant, to the receiver; and fixing the transferred ink image to the. receiver by subjecting the receiver to a fuser. The pigment or dye in the ink can be contained in at least one type of binder that is composed of fusible material such as one or more resins.

The present invention further relates to a printing method that includes applying a mixture containing at least one mordant and at least one release agent to a receiver. The mixture is optionally applied to the receiver by the fuser member.

The present invention also relates to a printing method that includes fixing both an ink jet image and a toner image to a receiver by subjecting the image bearing receiver to a fuser member. The fuser member can optionally apply heat and/or pressure to the receiver to fix the images.

In addition, the present invention relates to a printing method that includes applying at least one fixing agent to a receiver before, during, and/or after an ink jet image is transferred to the receiver. The fixing agent, e.g., mordant, may be applied on the surface of the receiver that receives the ink, or on the opposite side or both sides. The present invention can be used singly, for a monocolor printer having a single fuser; or sequentially, for a multiple color printer or for a printer with multiple print heads, each color or print head having a separate fuser. It can also be used for a printer having a combination of print heads, such as for a multiple color printer or for a printer with multiple print heads, that produces a complete image that is then fused in a single fuser.

It is to be understood that both the foregoing general description and the following detailed description are exemplary and explanatory only and are intended to provide a further explanation of the present invention, as claimed.

The accompanying drawings, which are incorporated in and constitute a part of this application, illustrate some of the embodiments of the present invention and together with the description, serve to explain the principles of the present invention.

### BRIEF DESCRIPTION OF DRAWINGS

FIG. 1 is a schematic illustration of a printing system that can be used in combination with a fixing agent according to the present invention.

FIG. 2 is a schematic illustration of a printing system that can be used in combination with a fixing agent applied simultaneously with the printed image and on the opposite side of the receiver, according to the present invention.

FIG. 3 is a schematic illustration of a printing system in which the fixing agent is applied before the image is printed by a separate applicator or by a preceding fuser.

### DETAILED DESCRIPTION OF THE PRESENT INVENTION

A printing method according to the present invention generally involves using a fixing agent that contains at least one mordant to fix an ink jet image to a receiver. The method includes transferring an ink image to a receiver; applying at least one fixing agent to the receiver; and fixing the transferred ink image to the receiver by subjecting the receiver to a fuser. The fixing agent is applied to the receiver before, during, and/or after transferring the ink image to the receiver, and can be applied on the surface of the receiver that receives the ink, or onto the opposite side or both sides. For purposes of the present invention, a fixing agent is a substance capable of holding an ink permanently on a substrate typically by chemical action or a combination of chemical/mechanical action. For purposes of the present invention, a fixing agent can include one or more mordants and/or it can include substances that aid in fixation of the mordant to the substrate or receiver. Preferably, the fixing agent contains the mordant and optionally other aids that fix the ink onto the substrate or receiver or assist in the fixation of the mordant on the substrate or receiver. Furthermore, with the use of the term “fix” or “fixing” as used herein in the present invention, the terms refer to a process wherein the ink (e.g., pigment and/or dye) is permanently held onto the receiver or substrate by typically a chemical action or a combination of chemical/mechanical actions, such that the ink cannot easily be removed from the substrate or receiver.

In more detail, the fixing agent of the present invention can contain at least one mordant. For purposes of the present invention, the mordant can include any compound, such as a salt or hydroxide of chromium, iron, aluminum, or tin, for instance, that is capable of fixing a colorant, such as a dye or a pigment, to (i.e., in or on) a substance, such as a fabric, leather, textile fiber, or paper, by combining with the colorant to form an insoluble compound. Exemplary mordants include, but are not limited to, vinegar, alum, aluminum potassium sulfate, tannin, urine, uric acid, and ammonia or other organic acids. Preferably, the mordant is a polymeric quaternary ammonium polymer or a polymeric quaternary phosphonium salt with alkyl, aryl, aralkyl, or heterocyclic groups. Other compounds that react with the colorant in the above-described manner can be used as the mordant. Examples of mordants are described, for example, in U.S. Pat. Nos. 6,503,978, 4,766,052; 4,619,883; 4,278,749; 4,234,671; 4,161,407; 4,128,538; 3,898,088; 3,859,096; 3,756,819; 3,758,445; 3,721,558; 3,698,896; 3,309,376; and 2,548,575, each of which is incorporated herein in its entirety by reference. The fixing agent can contain other conventional ingredients in addition to the mordant. More than one type of mordant can be present in the fixing agent.

The fixing agent of the present invention containing the mordant can be applied to the receiver using any technique or process. The fixing agent is preferably applied to at least a portion of, substantially all, or all of the entire area of the image-receiving surface(s) of the receiver. Preferably, the fixing agent is applied to the image-receiving surface(s) of the receiver in such a way as to form a film (e.g., mordant film) or layer on the receiver. The fixing agent can be applied to the receiver in any amount, for example, from about 0.01 to about 10 mg/cm², such as from about 0.1 to about 1 mg/cm. Preferably, the fixing agent is applied to the image-receiving surface(s) of the receiver in an amount that is sufficient to fix the ink image to the receiver. For quick action, the level of fixer agent in the fixer fluid is frequently in excess of what is required to fix the image. The concentration of fixing agent in the fixer fluid is typically between 1 and 15 wt %. The fixing agent can be applied to the receiver, particularly in the case of paper, preferably at a rate of from about 6 to about 6000 μl per 8½″ by 11″ (21.6 cm×29.9cm) receiver, and more preferably at a rate of from about 60 to about 600 μl per 8½″ by 11″ (21.6 cm×29.9cm) receiver, for instance. The applicator preferably can be adjusted to apply the fixing agent at the desired rate.

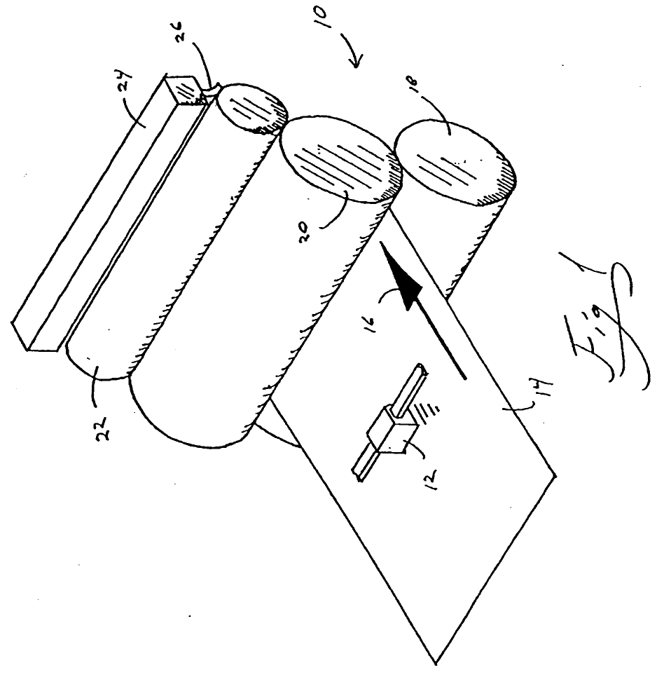

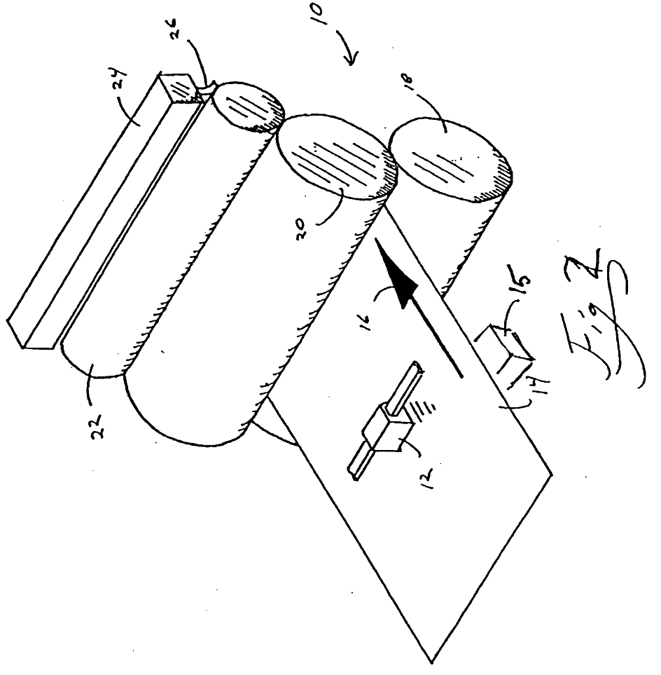

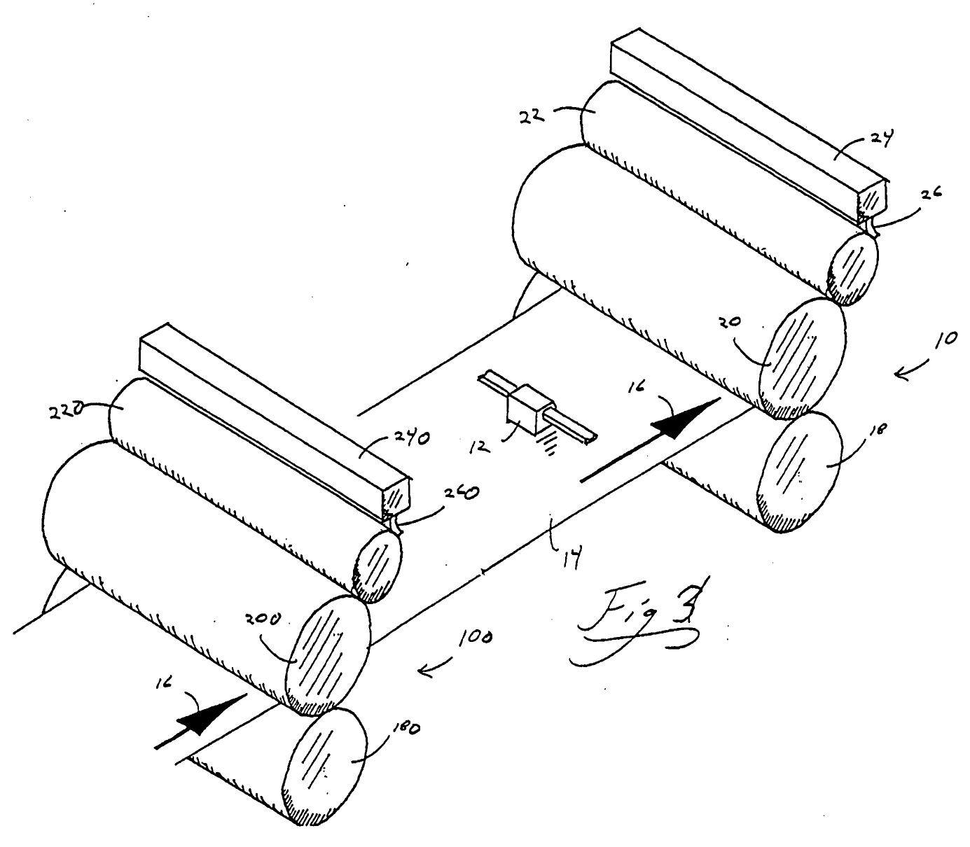

The fixing agent, e.g., mordant, can be applied to the receiver at any time with respect to the transferring of the ink image to the receiver. In other words, the fixing agent can be applied to the receiver before the ink image is transferred to the receiver (see FIG. 3), simultaneously to the transferring of the ink image to the receiver (see FIG. 2), and/or after the ink image is transferred to the receiver (see FIG. 1). The strategy depends on the absorption characteristic of the receiver. For relatively nonporous receivers the fixing agent should be applied after the ink image is transferred to the receiver. Otherwise the fixer agent could saturate the pores and not allow the ink to properly spread before being fixed. Also if the fixing agent does not penetrate quickly enough then this can lead to flooding of the ink on the surface resulting in poor image quality. For highly porous receivers like plain paper, preferably, the fixing agent is applied to the ink image-bearing receiver, that is, before or during the transfer of the ink image to the receiver. Combinations of applying fixing agent before and after transferring the image to the receiver could also be used to optimize fixing the image for maximum image quality and permanence.

Transferring the ink image to the receiver according to the present invention can be by any known method. Preferably, the ink image is an ink jet image or similar type of image. Accordingly, transferring the ink image to the receiver can be achieved by any ink jet delivery system. For example, the ink image can be transferred to the receiver via the print head, for instance, of any commercially available ink jet printer. The ink jet printer can be any single- or multi-pen print head.

Similarly, the ink image can be formed with any known ink. Preferably, the ink is an aqueous ink such as an ink jet ink. Preferred ink compositions contain glycols or alcohols. These inks can show improved uniformity of wetting when used with a receiver surface having a nonuniform coating of silicone oil, such as a receiver that has passed through a roller fuser. Other types of ink can be used such as non-aqueous and the like. Preferably, the ink contains a colorant media such as a pigment or a dye that can be fixed to the receiver by the formation of an insoluble compound with the fixing agent, e.g., mordant. Also, the ink can contain a mordant dye that is best used in combination with a mordant to be effective.

The receiver can be any substrate capable of accepting or bearing the ink image. For example, the receiver can be paper, polymeric materials including rubbers and plastics, coatings including clay coatings and primer coatings, fibers including polymeric fibers and textile fibers, reinforcing materials, fabrics, and/or cloth. Other materials having at least one surface capable of bearing an ink image can be used for the receiver. The receiver can be any size suitable for receiving an ink image, for instance, 8½″ by 11″ (21.6 cm×29.9cm). Other sizes are possible. At the time that the ink image is transferred to the receiver, and/or that the fixing agent, e.g., mordant, is applied to the receiver, the receiver can be blank or can contain one or more images, such as an ink image(s) or a toner image(s), which are fused or unfused, fixed or unfixed, and the like.

The type of ink used to form the ink image, the method of transferring the image to the receiver, and the type of receiver are not critical to the present invention. All ink jet printing means, inks, and receivers are well-known to those skilled in the art for transferring an ink image to a receiver. A suitable mordant can be selected based upon compatibility and effectiveness with the printing system, the ink, and the receiver used in practicing the present invention.

According to the present invention, the receiver bearing the ink image and the fixing agent, e.g., mordant, is subjected fixing energy from a fuser member or fuser to fix the ink image to the receiver. Preferably, the fuser member, directly or indirectly, contacts the image-bearing receiver. The fuser member can be in any type as long as it provides energy to fix the image, such as a non-contact fuser using microwaves, uv, or infra-red radiation, or a contact fuser such as a roller, plate, or belt. For example, the contact fuser member can be one or more cylindrical rollers. The fuser member can be any commercially available fuser roller. For purposes of the present invention, the term “fuser” or “fuse” have been used. While these terms are typically used with the use of toner materials to fuse the binder or resin onto a substrate, for purposes of the present invention, the terms “fuse” and “fuser” are meant not only to include the fusing of binder or resin material onto a substrate as that term is commonly understood but the term is also meant to apply heat and/or pressure to a ink image containing a fixing agent in order to at least assist in fixing the ink image to the receiver. The use of a fuser member or fuser to fix the ink image to the receiver can include, but is not limited to, applying heat and/or pressure to dry the ink image along with fixing agent and/or contribute to the time in which the ink becomes permanent on the receiver by chemical action or a combination of chemical/mechanical actions. Thus, the terms “fuser” and “fuser to fix” are not meant to be restrictive of fusing in the traditional sense but in a broader sense with respect to making an ink image permanent with the application of heat and/or pressure as discussed above and throughout the present application. Furthermore, in some embodiments of the present invention, the ink contains fusible material such as toner particles or other material containing resins. The fusing of these materials is meant to mean the conventional meaning of fusing fusible material such as toner particles. Thus, in such embodiments, the use of a fuser member to fix the ink image to the receiver can include not only fixing of the non-fusible material such as conventional ink jet ink along with the use of the fixing agent but also includes the fusing of the fusible material such as toner particles that may be part of the ink image which is applied to the receiver.

According to one embodiment of the present invention, the fixing agent, e.g., mordant, can be applied to the receiver by the fuser member. Thus, the fuser member can be used to supply or coat the receiver with the fixing agent, e.g., mordant. The fixing agent can be applied to the fuser member by any suitable applicator, including sump and delivery roller, jet sprayer, oiled pad, and the like. Preferably, the present invention employs a rotating wicking device or wick oiler to supply the fixing agent to the fuser member.

The fuser member can apply or not apply heat to the receiver. Preferably, the fuser member applies heat and/or pressure to the receiver. For fuser members that include two or more fusing surfaces, none, one, or more of the fusing surfaces can apply heat to the receiver. The fuser member can be capable of producing heat itself, and/or the fuser member can be heated by an external source. The method of providing heat from the fuser member to the receiver is not critical to the present invention and the fuser member can be heated by internal means, external means, or a combination of both. All heating means are well-known to those skilled in the art for providing sufficient heat to fuse the toner image to the image bearing surface. Examples of fuser members are described, for example, in U.S. Pat. Nos. 4,372,246; 4,905,050; 4,984,027; and 5,247,336, each of which is incorporated herein in its entirety by reference.

According to one embodiment, in addition to the ink image, the receiver can bear a toner image such as an electrophotographic toner image that can either be previously fused or not. The toner image can be any commercially available toner that is applied to the receiver by any commercially available apparatus or technique for forming a toner image. For a receiver of the present invention that bears a toner image that is not fused, the toner image can be fused to the receiver at the time that the receiver is subjected to the fuser member. Preferably, the fuser member applies pressure and/or heat to the receiver to at least partially, and preferably to substantially fuse the toner image to the receiver. Preferably, the fuser member can apply pressure and/or heat to the receiver sufficient to fuse the previously unfused toner. For example, the fuser member can apply heat to the receiver at a temperature of from about 80 to about 250° C. For a receiver of the present invention that bears a toner image that has been fused previously, the toner image can be subjected to the fuser member substantially or completely without offset.

In using a receiver bearing an ink image(s), and/or both an ink image(s) and a toner image(s), a release agent can be applied to the fuser member surface so that the release agent contacts the image(s) on the receiver, and can also contact the receiver, during the operation of the fuser member. The release agent can be used for contact fusers and generally release agents are not preferably used for non-contact fusers. Particularly where the fuser base is a cylindrical roller or an endless belt, the release agent is applied, while the base is rotating or the belt is running, upstream of the contact area between the fuser member and the receiver.

If the optional release agent is used in the present invention, the release agent is preferably applied so as to form a film on the fuser member surface. Preferably, the release agent is applied so as to form a film that completely, or at least essentially, or at least substantially, covers the fuser surface. Also as a matter of preference, during operation of the system the release agent is applied continuously, or semi-continuously or substantially continuously, to the fuser surface.

Release agents are intended to prohibit, or at least lessen, an offset of the toner from the receiver to the fuser surface, and if a release agent is employed, preferably, it acts accordingly. In performing this function, the release agent can form, or participate in the formation of, a barrier or film that releases the toner. Thereby the toner and/or ink are inhibited in its contacting of, or at least prevented from adhering to, the fuser surface.

The release agent can be a fluid, such as an oil or other liquid, and is preferably an oil, i.e., a fuser oil. It can be a solid or a liquid at ambient temperature, and a fluid at operating temperatures. Preferably, the release agent is a polymeric release agent, and more preferably, is a silicone or polyorganosiloxane oil.

The release agent can have a viscosity greater than about 200 cSt at ambient temperature, preferably greater than about 300 cSt, still more preferably between about 300 and 100,000 cSt viscosity, and yet still more preferably between about 20,000 and about 100,000 cSt viscosity at ambient temperature.

Further, release agents which can be used in combination with a fixing agent of the present invention include polymeric release agents having functional groups. Suitable polymeric release agents with functional groups include those which may be found as liquids or solids at room temperature, but are fluids at operating temperatures.

Particular functional group containing polymeric release agents that can be used include those set forth in U.S. Pat. Nos. 4,011,362 and 4,046,795, incorporated herein in their entireties by reference. Other release agents which may be used are the mercapto functional polyorganosiloxanes described in U.S. Pat. No. 4,029,827, and the polymeric release agents having functional groups such as carboxy, hydroxy, epoxy, amino, isocyanate, thioether, and mercapto functional groups as described in U.S. Pat. Nos. 4,101,686 and 4,185,140, each of which is incorporated herein in its entirety, by reference.

The functional agents can be diluted with nonfunctional polyorganosiloxanes, particularly nonfunctional polydimethylsiloxanes. Further, it is preferred to obtain good release activity with a functional release agent, monofunctionality is preferred, so that the molecule cannot react both with the toner and/or ink and with the fusing surface layer to serve as an image/fuser member adhesive. Therefore, the functional agent preferably contains a substantial portion of the mono-functional molecule.

Therefore, the functional polyorganosiloxane preferably contains as great a proportion of the monofunctional moiety as is practically possible. Preferably, the functional polyorganosiloxane has a sufficient monofunctional proportion so as not to act as the indicated adhesive.

Accordingly, a preferred release agent composition contains a blend of nonfunctional polyorganosiloxane, particularly nonfunctional polydimethylsiloxane, with amino functional polyorganosiloxane, and the amino functional polyorganosiloxane contains monoamino functional polyorganosiloxane. Another preferred release agent composition contains a blend of nonfunctional polyorganosiloxane, particularly nonfunctional polydimethylsiloxane, with mercapto functional polyorganosiloxane which preferably includes monomercapto functional polyorganosiloxane.

The release agent can be applied to the fuser member by any suitable applicator, including sump and delivery roller, jet sprayer, oiled pad, and the like, for instance, as described in U.S. Pat. Nos. 5,017,432 and 4,257,699, incorporated herein in their entirety, by reference. Preferably the present invention employs a rotating wicking device or wick oiler to apply the release agent to the fuser member.

A wick oiler contains a storage compartment or reservoir for the release agent and a wick in fluid connection with the reservoir. In operating the printing apparatus of the present invention, the wick can be situated so as to be in contact with the stored release agent and also with the fusing surface layer of the fuser member. The wick can pick up release agent and transport it to the fuser member. A rotating wick oiler further rotates in conjunction with the fuser surface and does not slide against the surface. In this manner streaks in the applied oil layer and/or abrasion of the fuser surface layer are avoided.

The release agent can be applied to the receiver, particularly in the case of paper, preferably at a rate of from about 0.1 to about 20 μl per 8½″ by 11″ (21.6 cm×29.9 cm) receiver, and more preferably at a rate of from about 1 to about 8 μl per 8½″ by 11″ (21.6 cm×29.9 cm) receiver, for instance. The applicator preferably can be adjusted to apply the release agent at the desired rate.

According to one embodiment of the present invention, the fixing agent, e.g., mordant, and the release agent are together applied to the receiver via the fuser member. The fixing agent, e.g., mordant, and the release agent can be stored separately and supplied to the fuser member separately; stored separately and mixed together on the way to the fuser member; and/or stored as a mixture in a compartment or reservoir. When optionally applied together in any manner as described above, the fixing agent, e.g., mordant, and the release agent can be present in any weight ratio, for example in a ratio of about 600:1, or about 1:5. Other ratios are possible.

As illustrated in FIG. 1, a printing system 10 includes an ink jet print head 12 that deposits ink on a receiver 14, such as a sheet of paper, to form an ink image (not shown). The portion of the receiver 14 on which ink has been deposited is fed in the direction indicated by the arrow 16 to one or more fuser rollers 18, 20. One or both of the fuser rollers 18, 20 can be heated above room temperature. When the receiver 16 passes between the rollers 18, 20, the heat accelerates the rate at which the ink on the receiver 14 dries.

The elevated temperature can be used to dry ink jet images while they are in the fuser nip and after they pass through the fuser. More rapid drying of the ink jet images can reduce image spread, improve resolution, and improves media independence. For example, ink jet drops air-dried on coated paper generally spread less than drops on uncoated, fibrous paper. Reducing drying time can allow comparable image quality to be obtained with very different types of papers. The temperature of the rollers 18, 20 can be adjusted to accommodate differences in the type of media, the type of ink, the desired resolution and the like.

One or more of the fuser rollers 18, 20 can operate to apply a fixing agent (e.g., mordant) to the receiver 14. Optionally, the fixing agent can be applied to the receiver 14 by any other means before the receiver 14 reaches the fuser rollers 18, 20, for example, before and/or after the ink image is applied to the receiver 14 by the print head 12. This is shown in FIG. 2 wherein an applicator 15 applies a fixing agent to receiver 14 at about the same time that print head 12 applies an ink image. The fixing agent can be applied to the fuser roller 20 through a secondary roller 22. A reservoir 24 can store a supply of fixing agent, which can be transferred to the secondary roller 22 by a wick 26 or by another applicator. The fixing agent, e.g., mordant, can be selected according to the ink jet ink used so as to combine with colored portions of the ink to form an insoluble compound that is fixed to the receiver. FIG. 3 shows an embodiment where a fixing agent is applied before the image is printed by print head 12. Rollers 180 and 200 are similar in nature to rollers 18 and 20, and can be simple feeder rollers or fuser rollers. A secondary roller 220 can also be used and a reservoir 240 can store the fixing agent. FIG. 3 is an embodiment where the fixing agent is first applied with or without fusing and after an ink image is formed (with or without fusible material) the roller system 10 is used to fuse the image. Alternately, non-contact fusing methods may be used, such as microwave, uv, or infra-red fusing.

As the receiver 14 passes through the rollers 18, 20, ink jet images printed on the receiver 14 are fixed by simultaneously heating the receiver and applying a fixing agent to the receiver. The same roller 20 can be used to apply the fixing agent and to apply heat to the receiver. Thermally-driven chemical reactions with the ink and evaporation of the ink medium can fix the ink jet image on the receiver 14 .

The ink jet images can be printed on blank receivers, or on pre-printed receivers containing offset images, ink jet images, and/or toner images, for example.

In addition to a fixing agent, e.g., mordant, a release agent, e.g., silicone oil, can also be coated on one or more fuser rollers. This allows toner images to be fused simultaneously with ink jet images on the same receiver. If the toner image has previously been fused, it can be passed through the fuser without offset of toner onto the fuser rollers. Thus, a printing method can include applying a toner image and an ink jet image to the same receiver and fusing the toner image only after the ink jet image has been applied to the receiver. In one embodiment, the ink jet image is applied to an unfused toner image. As the toner image is fused, a fixing agent, e.g., mordant, can also be applied to the receiver for the ink jet image. The ink jet image can be fixed as the toner image is fused.

The fixing agent, for instance, mordant, used in the printing system 10 may be mixed with a release agent or fuser oil. In that case, the mordant/oil mixture may be stored separately and then mixed together, or stored as a combination in the reservoir 24 for subsequent application to the fuser roller 20.

As one option, at least one type of fusible material can be applied to the receiver simultaneously with the printing of the ink image or transferring of the ink image to the receiver. This simultaneous or nearly simultaneous application of the at least one type of fusible material with the transferring or printing of the ink image can be done any number of ways. For instance, the fusible material can be applied using a separate cartridge and be present with other ink providing cartridges. For example, U.S. Pat. No. 6,147,139 uses an ink which contains a mixture of a colorant and clear fusible particles. Alternatively, and more preferably, a fusible material is present that contains the colorant as part of the fusible material. The presence of the fusible material permits the ink image that is printed or transferred to a receiver to be fused by a fuser member. This type of ink formulation is more effective at fixing the colorant since it is already present in the fusible material. This type of formulation also minimizes or avoids the use of a mordant and permits the image of the ink, and preferably an ink jet image, to be fused by a fuser member. The ink formulation, therefore, preferably contains at least one colorant such as a pigment or a dye, at least one type of fusible material, and preferably at least one surfactant and/or dispersant. The fusible material preferably contains at least one resin, for instance, clear toner or colored toner particles formed by limited coalescence as shown in U.S. Pat. No. 4,833,060, incorporated in its entirety by reference. The fusible material is preferably polymeric and can be prepared from any type of polymer that is capable of being dissolved in a solvent that is immiscible with water and includes for example, olefin homopolymers and copolymers, such as polyethylene, polypropylene, polyisobutylene, and polyisopentylene; polyfluoroolefins, such as polytetrafluoroethylene and polytrifluorochloroethylene; polyamides, such as poly(hexamethylene adipamide), poly(hexamethylene sebacamide), and polycaprolactam; acrylic resins, such as poly(methyl methacrylate), poly(methyl acrylate), poly(ethyl methacrylate), styrene-methyl methacrylate copolymers; ethylene-methyl acrylate copolymers, ethylene-ethyl acrylate copolymers, ethylene-ethyl methacrylate copolymers, polystyrene and copolymers of styrene with unsaturated monomers , cellulose derivatives, such as cellulose acetate, cellulose acetate butyrate, cellulose propionate, cellulose acetate propionate, and ethyl cellulose; polyesters, such as the polyester derived from fumaric acid and ethoxylated Bisphenol A, polycarbonates, such as Bisphenol A polycarbonate; polyvinyl resins, such as polyvinyl chloride, copolymers of vinyl chloride and vinyl acetate, and poly(vinyl butyral), poly(vinyl acetal), ethylene-vinyl acetate copolymers, ethylene-vinyl alcohol copolymers, and ethylene-allyl copolymers, such as ethylene-allyl alcohol copolymers, ethylene-allyl acetate copolymers, ethylene-allyl benzene copolymers ethylene-allyl ether copolymers, and ethylene-acrylic copolymers; poly(oxymethylene), and polyurethanes, and the like. The fusible material can be solid particles having an average particle size of less than 3 microns, and preferably less than 2 microns, and more preferably less than 1 micron, which are suspended in the ink formulation with the use of a surfactant and/or dispersant. The amount of the fusible material present in the ink formulation is an amount sufficient to permit the ink to be fused by at least one fuser member. Preferably, the amount of fusible material is from about 5 to about 50 wt % and more preferably from about 20 to about 40 wt % based on the weight of the overall ink formulation. The choice of dispersant or surfactant to stabilize the fusible particles will depend on the polymer system used.

Some examples of dispersants include condensed phosphates and organic polymeric dispersants

The Table below lists dispersant materials by types and trademarked names for each class of materials.

Poly(meth)acrylates (3), where R=H, CH₃: n<100,000; and Y═OH, OCH₃, O⁻Na+, etc., or copolymers with compatible monomers, are probably the most flexible dispersant products, because they are produced in a variety of molecular weights and degrees of anionic charge. Moreover, reaction of acrylic acid with other monomers confers additional properties.

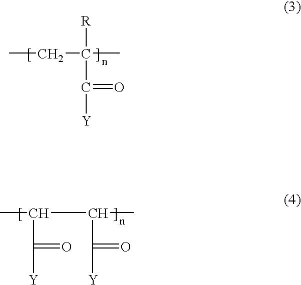

Polymaleates (4), where n<100,000 and Y═OH, , O^{—}Na+, or copolymers with compatible monomers such as styrene, acrylic acid, etc., generally show properties similar to those of poly(meth)acrylates. Na-naphthalensulfonic acid-formaldehyde condensates and melamine-formaldehyde condensates are further examples. Natural product-derived dispersants, such as, tannins, lignins, and alginates, are further examples.

TABLE
Examples of dispersants*

| Chemical name | Manufacturers | Trademarks |
|---|---|---|
| Poly(meth)acrylates | Alco Chemical | Alcosperse, |
| | | Aquatreat |
| | Allied Colloid, Ltd. | Antiprex, Alcomer |
| | American Cyanamid | Cyanamer |
| | Co. | |
| | FMC Corp. | Belsperse |
| | Rohm and Haas Co. | Acusol, Acumer, |
| | | Tamol |
| | W.R. Grace & Co. | Daxad |
| Polymaleates | BASF Corp. | Sokolan |
| | FMC Corp. | Belgard, Belasol |
| | NorsoHaas S.A. | Norasol |
| Condensed phosphates | Calgon Corp. | B |
| | FMC Corp. | B |
| | Monsanto Chemical | B |
| Polysulfonates^{c} | National Starch & | Versa TL |
| | Chemical Corp. | |
| | Westvaco Corp. | Polyfon, Reax, |
| | | Indulin |
| | Borregaard Industries, | Vanisperse, |
| | Ltd. | Borresperse, |
| | | Ultrazine |
| Sulfonated | Diamond-Shamrock | Lomar |
| polycondensates^{c} | Corp. | |
| | Rohm and Haas Co. | Tamol |
| Tannins, lignins, | Georgia-Pacific Corp. | B |
| glucosides, alginates^{d} | Kimberly-Clark Corp. | B |
| | Marathon Paper Co. | Marasperse |

^{c}Polymeric structures having pendent SO₃ groups, lignosulfates, and polystyrenesulfonates, including naphthalenesulfonate-formaldehyde condensates
^{d}Polymeric materials derived from natural products
*From Encylopedia of Chemical Technology, Wiley-Interscience Publishers, Volume 8, p. 293.

The surfactant and/or dispersant is present in an amount to sufficiently suspend the fusible material substantially uniformly throughout the ink formulation so that the fusible material and remaining parts of the ink formulation are uniformly and evenly transferred or printed onto a receiver. In other words, the fusible material should be adequately suspended or dispersed throughout the ink formulation so that every ink image transferred onto a receiver has sufficient fusible material with the ink image in order to be fused by at least one fuser member. The amount of surfactant and/or dispersant present to accomplish this purpose will depend on the surface area of the fusible particles and the relative number of active groups in the dispersant/and or surfactant. The formulation can be prepared by mixing the components together using standard techniques.

The previously described versions of the present invention have many advantages, including rapid drying of ink jet images that reduces image spread and distortion, improves resolution, improves media independence, and allows an increased imaged receiver output rate. In addition, an ink image(s) and a toner image(s) can be fixed simultaneously to a receiver. Also, an ink image(s) can be fixed to a receiver that bears a previously fixed (e.g., fused) ink jet image(s) and/or toner image(s) without offset of the toner.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1. A printing method comprising:
transferring an ink image to a receiver;
applying at least one fixing agent comprising at least one mordant to said receiver; and
fixing said transferred ink image to said receiver by subjecting said receiver to fixing energy.

2. The printing method of claim 1, wherein said fixing agent is applied to said receiver before said ink image is transferred to said receiver.

3. The printing method of claim 1, wherein said fixing agent is applied to said receiver after said ink image is transferred to said receiver.

4. The printing method of claim 1, wherein said fixing agent is applied to said receiver by a fuser member.

5. The printing method of claim 1, further comprising applying a release agent to said receiver after said ink image is transferred to said receiver.

6. The printing method of claim 5, wherein said release agent is applied to said receiver by a fuser member.

7. The printing method of claim 5, wherein said release agent and said fixing agent are applied to said receiver by a fuser member.

8. The printing method of claim 7, further comprising disposing a mixture in a reservoir, wherein said mixture comprises said fixing agent and said release agent.

9. The printing method of claim 8, further comprising wicking said mixture from said reservoir to said fuser member.

10. The printing method of claim 1, wherein a fuser member applies fixing energy to said receiver at a temperature of from about 80 to about 250° C.

11. The printing method of claim 1, wherein said fixing energy is applied by a fuser member comprising at least one fuser roller, at least one fuser belt, or at least one fuser plate, or a combination thereof.

12. An ink image formed by the printing method of claim 1.

13. An article bearing the ink image of claim 12.

14. The printing method of claim 1, wherein said receiver also bears a toner image.

15. The printing method of claim 14, wherein said toner image is fused to said receiver before said ink image is transferred to said receiver.

16. The printing method of claim 14, further comprising fusing said toner image to said receiver utilizing a fuser member.

17. An ink image and a toner image formed by the printing method of claim 14.

18. An article bearing the ink image and the toner image of claim 17.

19. A printing apparatus comprising:
an ink image forming device adapted to transfer an ink image to a receiver;
a supply of at least one fixing agent comprising at least one mordant, wherein said at least one fixing agent is adapted to be applied to said receiver; and
a fuser member adapted to fix said transferred ink image to said receiver.

20. The printing apparatus of claim 19, wherein said ink image forming device comprises a print head of an ink jet printer.

21. The printing apparatus of claim 19, wherein said fixing agent comprises at least one organic acid or polymeric acid, or any combination thereof.

22. The printing apparatus of claim 19, wherein said fuser member comprises at least one roller fuser, at least one fuser belt, or at least one fuser plate, or a combination thereof.

23. The printing apparatus of claim 19, wherein said fuser member is adapted to apply heat to said receiver at a temperature of from about 80 to about 250° C.

24. The printing apparatus of claim 19, wherein said fuser member is adapted to apply said fixing agent to said receiver.

25. The printing apparatus of claim 19, further comprising a release agent adapted to be applied to said receiver.

26. The printing apparatus of claim 25, wherein said fuser member is adapted to apply said release agent to said receiver.

27. The printing apparatus of claim 25, wherein said fuser member is adapted to apply a combination containing said release agent and said fixing agent to said receiver.

28. The printing apparatus of claim 25, further comprising a reservoir for containing a combination comprising said fixing agent and said release agent.

29. The printing apparatus of claim 28, further comprising a wicking device adapted to transport said combination from said reservoir to said fuser member.

30. The printing apparatus of claim 25, wherein said receiver bears a toner image.

31. The printing apparatus of claim 30, wherein said fuser member is adapted to fuse said toner image to said receiver.

32. An ink formulation comprising at least one fusible material, at least one colorant contained within the fusible, material, and at least one surfactant and/or dispersant.

33. The ink formulation of. claim 32, wherein said fusible material comprises toner particles having a particle size of less than 3 microns.

34. The ink formulation of claim 32, wherein said fusible material is formed by limited coalescence.

35. The ink formulation of claim 32, wherein said fusible material is present in an amount of from about 5 to about 50 wt % based on the weight percent of the ink formulation.

36. The ink formulation of claim 32, wherein said fusible material is suspended in said ink formulation.

37. The ink formulation of claim 32, wherein said ink formulation is an aqueous or solvent ink jet formulation.

38. The ink formulation of claim 32, wherein said dispersant comprises at least one organic polymeric dispersant.

39. The ink formulation of claim 32, wherein said dispersant comprises at least one poly(meth)acrylic or polymaleate, or both.

40. A printing method comprising:
transferring an ink image formed from the ink formulation of claim 32 to a receiver; and
fixing said transferred ink image to said receiver by subjecting said receiver to a least one fuser member.

41. The printing method of claim 1, wherein said ink image comprises a fusible material.

42. The printing method of claim 41, wherein said fusible material comprises at least one resin.

43. The printing method of claim 1, wherein said fixing agent is applied to said receiver before said ink image is transferred to said receiver, at about the same time that said ink image is transferred to said receiver, after said ink image is transferred to said receiver, or combinations thereof.

44. The printing method of claim 1, wherein said receiver already bears an ink jet ink image from a single or multi-pass color printing.

45. The printing method of claim 44, wherein said ink jet ink image is fused to said receiver before said ink image is transferred to said receiver.

46. The printing method of claim 45, further comprising fusing said ink jet image to said receiver utilizing said fuser member.

47. The printing method of claim 40, wherein said receiver contains at least one fixing agent prior to, during, or after said transferring of said ink image.

48. The ink formulation of claim 32 wherein said fusible material is a polyester.

49. The ink formulation of claim 48 wherein said polyester comprises a polyester derived from fumaric acid and ethoxylated Bisphenol A.

50. The method of claim 43 wherein the fixing agent is applied from the image side or the opposite side of the receiver.
